(19) United States
(12) Patent Application Publication
(10) Pub. No.: US 2005/0273839 A1
(43) Pub. Date: Dec. 8, 2005

(54) System and method for automated context-based data presentation

(75) Inventors: Kimmo M. Mikkonen, Kerava (FI); Tero E. Nordstrom, Espoo (FI); Mika Leppinen, Espoo (FI)

Correspondence Address: FOLEY & LARDNER, 321 NORTH CLARK STREET, SUITE 2800, CHICAGO, IL, 60610-4764, US

(73) Assignee: Nokia Corporation

(21) Appl. No.: 10/858,834

(22) Filed: Jun. 2, 2004

(51) Int. Cl. H04N 7/16; H04B 1/66; H04N 7/12

(52) U.S. Cl. 725/135; 715/513

(57) ABSTRACT

The techniques described include presenting data based on a context. An exemplary technique involves defining a data context that includes keywords and data related to the data context, selecting a current data context, and providing an application with files only satisfying the current data context.

### BACKGROUND OF THE INVENTION

1. Field of the Invention

The present invention relates generally to the access and management of data in mobile terminals, computers, personal digital assistants and any paralleled electronic devices. More particularly, the present invention relates to automated context-based data orchestration in these devices.

2. Description of the Related Art

This section is intended to provide a background or context to the invention that is recited in the claims. The description herein may include concepts that could be pursued, but are not necessarily ones that have been previously conceived or pursued. Therefore, unless otherwise indicated herein, what is described in this section is not prior art to the claims in this application and is not admitted to be prior art by inclusion in this section.

Currently, data organization on mobile devices, computers or any comparable device, in which browsing actions are needed, is completely the users' responsibility and there are not many tools for helping the user. In the future, it is very likely that the amount of data in these devices will rise considerably and therefore data orchestration will become a more difficult and time-consuming task.

Known networked systems have included automated context data management. For example, patent application Ser. No. WO 03/065240 describes an automated context base data management system for networked systems. Operating systems also provide some automated context data management. However, such systems are limited and have disadvantages.

There is a need to organize and find data as device storage capability increases. Further, there is a need for automated/user created data contexts to categorize data, especially in the context of handheld devices due their limited capability of input means (keyboard, touch-sensitive screens etc.).

### SUMMARY OF THE INVENTION

In general, exemplary embodiments described herein provide access and management of data in electronic devices. These embodiments present ways to show only the data that is relevant to the user at the selected context. The user can have different views to data (e.g., pictures, music, sound, emails, SMS, MMS, etc.); however, only the relevant data is shown to the user. Views are changed according to the data context that user has selected or automatically based on pre-defined triggers (triggered for example when user moves to a certain locations or uses device on certain time of a day).

One exemplary embodiment relates to a method of presenting data based on a context. The method includes defining a data context that includes keywords and data related to the data context, selecting a current data context, and providing an application with files only satisfying the current data context.

Another exemplary embodiment relates to a system for presenting data based on a context. The system includes an application that requests data, a database containing data context data, and a filter that restricts data to the application to data pertaining to a currently selected data context based on corresponding data context data from the database.

Another exemplary embodiment relates to a device that presents data based on a data context. The device includes a memory containing data context information, a user interface that presents data conforming to a selected data context, and a processor that executes instructions to obtain data context information from the memory, select a data context, and restrict data available for presentation on the user interface to selected data context data.

Another exemplary embodiment relates to a computer program product, which limits data presented to a user to data satisfying a selected data context. The computer program product includes computer code to define a data context based on user input or automated instructions, computer code to select a current data context, computer code to add data to the current data context, and computer code to present data satisfying the data context.

Yet another exemplary embodiment relates to a module that automates data presentation based on a data context. The module includes a memory structure containing data context data for a plurality of data contexts and a filter that restricts data to applications to data satisfying a currently selected data context based on corresponding data context data from the memory structure.

### BRIEF DESCRIPTION OF DRAWINGS

FIG. 1 is a general diagram depicting a context filtering system in accordance with an exemplary embodiment.

FIG. 2 is a diagram depicting an exemplary framework of layers including an application layer with context filtering.

FIG. 3 is a diagram depicting a data context definition including keywords and data related to the context.

FIG. 4 is a diagram depicting a communication system including the context filtering system of FIG. 1.

FIG. 5 is a flow diagram of exemplary data context creation and use in accordance with an exemplary embodiment.

### DETAILED DESCRIPTION OF EXEMPLARY EMBODIMENTS

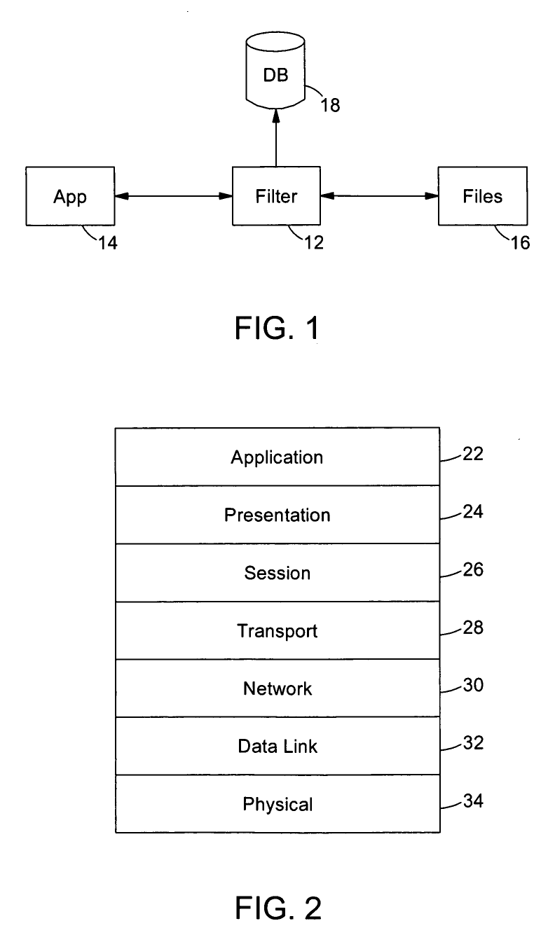

FIG. 1 illustrates a filter 12 between applications 14 and files 16. The filter 12 can be integrated into a browsing or file management system. The filter 12 can be a separate layer that allows only context-matching files through to the applications 14 that request data from the files 16. The filter 12 can be used with every application in a device. The filter may be implemented in the browser of the system, or it can be implemented apart from the browser. The filter 12 obtains context data from a database 18, which may or may not be the same storage used by the files 16.

The filter 12 can restrict files 16 from the applications 14 based on extensions in the file names, dates of file creation, data managing system or any desired limitation. Other filtering techniques can also be utilized to permit only files pertaining to particular contexts to be transmitted to an application.

Every context has data that defines the context itself. The context definition is separate from the actual data of the context. Moreover, in an alternative embodiment, it is possible to create a separate data structure for storing context information or to include meta-data information within the file system.

FIG. 2 illustrates a general diagram of layers of related functions used in an exemplary system. Data contexts can be implemented in an application layer 22 that handles device data storage. The application layer 22 can be implemented so that the applications do not need to know about different data context. When different applications are being used, the application layer 22 automatically filters only those files/data storages that belong to the currently selected data context.

The application layer 22 can be implemented with other layers, including a presentation layer 24, a session layer 26, a transport layer 28, a network layer 30, a data-link layer 32, and a physical layer 34. Additional, fewer, or different layers may be used, depending on the embodiment. The presentation layer 24 converts incoming and outgoing data from one presentation format to another (for example, from a text stream into a popup window with the newly arrived text). The session layer 26 sets up, coordinates, and terminates conversations, exchanges, and dialogs between the applications at each end. It deals with session and connection coordination. The transport layer 28 manages the end-to-end control (for example, determining whether all packets have arrived) and error-checking. The network layer 30 handles the routing of the data (sending it in the right direction to the right destination on outgoing transmissions and receiving incoming transmissions at the packet level). The data-link layer 32 provides synchronization for the physical level. The physical layer 34 conveys the bit stream through the network at the electrical and mechanical level. It provides the hardware means of sending and receiving data on a carrier.

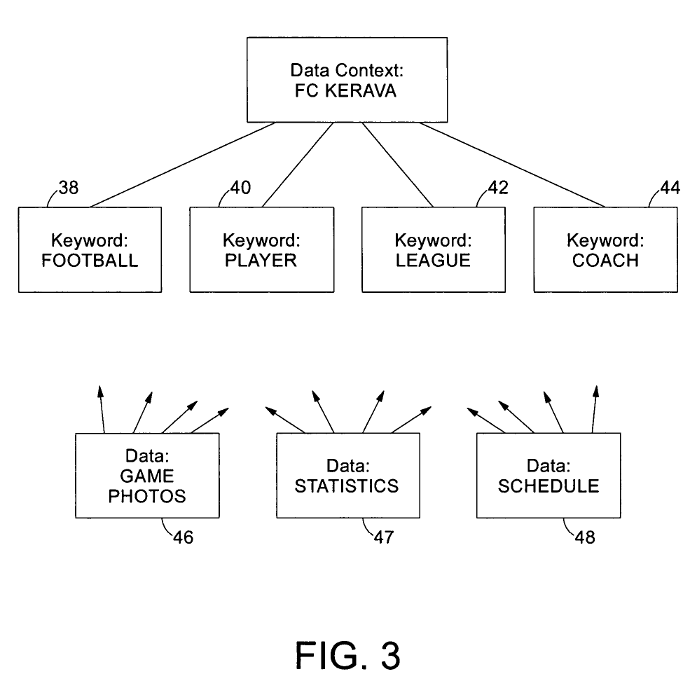

FIG. 3 illustrates a data context definition including keywords and data related to the context. Context information and data related to each data context could be shared among different users (e.g. with members of a team). Using this kind of solution, different groups can share data that is related to that particular group. An example of data context definition can be a situation where the user is playing football in a football team. For handling data related to this hobby, a user creates a data context 36 called ‘FC Kerava’. A data context definition for this data context can include keywords, such as football, player, league and coach (illustrated in FIG. 3 as keywords 38, 40, 42, and 44). Keywords 38, 40, 42, and 44 may be used to classify what data belongs to the new data context. As such, the classification can be done using self-organizing maps or algorithms. After the data context is defined, the user can change to this context and start adding data to it. Keywords 38, 40, 42, and 44 can be associated with data 46, 47, and 48 including, for example, game photos, statistics, and schedules for the FC Kerava football club. In this phase it must be mentioned, that information may belong to more than one context.

The data context definition can also identify persons that belong to the data context. Using this functionality, it is possible, for example, to open a phonebook and see only the phone numbers of team members. When using this data context, if the user opens the media gallery application, he or she only sees pictures and/or movies that are related the football team. When the user opens the messaging application, he or she only sees SMS, MMS and email messages that are arrived from or sent to the members of the football team.

Definitions used to define data contexts are something that can be shared among different users. An example of this is a situation, where the coach of the team creates ‘FC Kerava’ data context, defines the selected keywords, and adds some data to it. For example, the coach can add pictures from the highlights of the previous season, stored in his multi-media card or any other comparable device for data storing purpose. After this, the coach can share this data context with all the members of the team using Bluetooth, GPRS or any other comparable means, covering both wireless and non-wireless means. Each team member gets the data context definition and also the initial data that is contained in the data context. After this, team members can start adding data (e.g, photos) to this data context. Every once in a while, each team member can synchronize the data context with the creator or other members of the context (in this case the coach or the other players in the team) and in this way receive new data created by other team members.

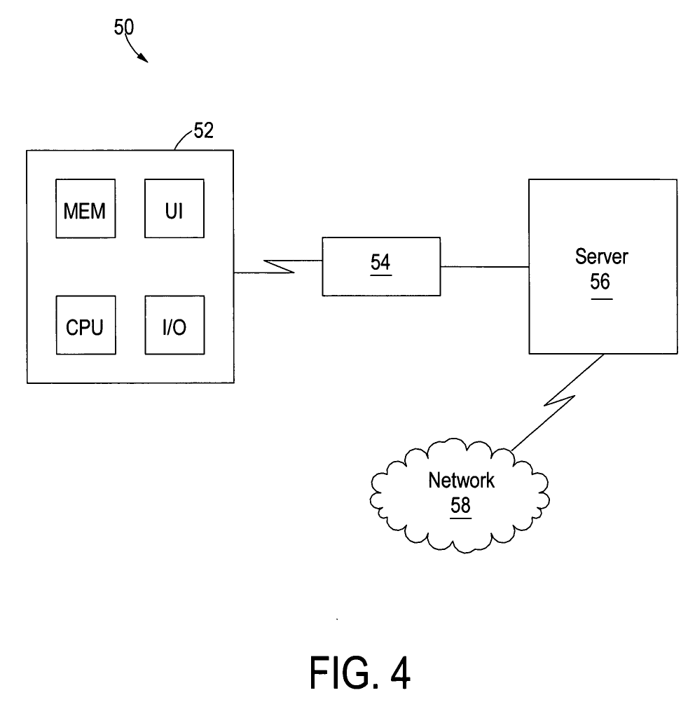

FIG. 4 illustrates a communication system 50 including the context control features described herein. The exemplary embodiments described herein can be applied to any communications system including an electronic device and a server, between which data can be transmitted. Moreover, the devices between which there is communication may be different types of devices (e.g., one can be a laptop computer and the other can be a mobile phone).

Communication system 50 includes a terminal equipment (TE) device 52, an access point (AP) 54, a server 56, and a network 58. The TE device 52 can include memory (MEM), a central processing unit (CPU), a user interface (UI), and an input-output interface (I/O). The memory can include non-volatile memory for storing applications that control the CPU and random access memory for data processing. A context control module can be implemented by executing in the CPU programmed instructions stored in the memory. The I/O interface can include a network interface card of a wireless local area network, such as one of the cards based on the IEEE 802.11 standards.

The TE device 52 can be connected to the network 58 (e.g., a local area network (LAN), the Internet, a phone network) via the access point 54 and further to the server 56. The TE device 52 can also communicate directly with the server 56, for instance using a cable, infrared, or a data transmission at radio frequencies. The server 56 can provide various processing functions for the TE device 52. Data exchange can be performed either between two devices directly, or the data can be stored into the server 56, and be shared between the devices.

The TE device 52 can be any portable electronic device, in which speech recognition is performed, for example a personal digital assistant (PDA) device, remote controller or a combination of an earpiece and a microphone. The TE device 52 can be a supplementary device used by a computer or a mobile station, in which case the data transmission to the server 56 can be arranged via a computer or a mobile station. In an exemplary embodiment, the TE device 52 is a mobile station communicating with a public land mobile network, to which also the server 56 is functionally connected. The TE device 52 connected to the network 58 includes mobile station functionality for communicating with the network 58 wirelessly. The network 18 can be any known wireless network, for instance a network supporting the GSM service, a network supporting the GPRS (General Packet Radio Service), or a third generation mobile network, such the UMTS (Universal Mobile Telecommunications System) network according to the 3GPP (3^{rd} Generation Partnership Project) standard. The functionality of the server 56 can also be implemented in the mobile network. The TE device 56 can be a mobile phone used for speaking only, or it can also contain PDA (Personal Digital Assistant) functionality.

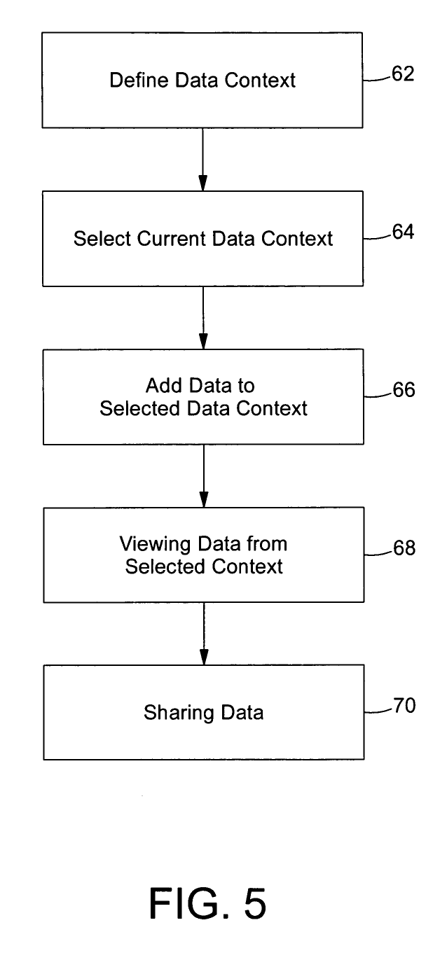

FIG. 5 illustrates a flow diagram of exemplary operations in the creation and use of data contexts for categorizing and presenting data. Additional, fewer, or different operations may be performed, depending on the embodiment. Further, the operations can be performed in any order.

Data context handling can include defining the data context (either by the user or by the phone automatically) (operation 62), selecting the current data context (operation 64), adding data to the selected data context using different applications found from the phone (operation 66), viewing data found from the selected data context (operation 68), and sharing data context definitions and actual data between a group of users (operation 70).

In an embodiment where the data context functionality is implemented on a phone or other similar communication device, the user can see a list of data contexts by pressing the power button of the phone. Each data context can have an icon or user interface theme that is visible to the user when he or she is using the phone. In an exemplary embodiment, the icon can be visible in the status bar of a user interface.

In another exemplary embodiment, automatic context definition assumes that there is possibility to define meta-data related to the data on the phone. Meta-data are attributes that can define which context data belongs to, location of the phone at the creation moment, URL used to download the data, some indexed words (taken from the document content), etc. This meta-data can be extended, for example, from the format defined by RDF (Resource Decision Framework for the World Wide Web Consortium). With meta-data, every document has some attributes describing document. In such embodiments, meta-data is automatically created based on the information that document contains, location when document was accessed, sound environment when document was accessed, source of the document (e.g. e-mail) etc. After meta-data is defined, related documents can be linked together using self-organizing maps algorithms. Self-organizing maps organize data and finding new contexts.

A self-organizing map (SOM) is a group of neurons that are organized as a grid M=[mₗ, . . . mₙ]. The SOM algorithm is based on unsupervised, competitive learning. It provides a topology-preserving mapping from the high dimensional space to map units. Topology preserving refers to the fact that the mapping preserves the relative distance between the points. Map units, or neurons, usually form a two-dimensional lattice and thus the mapping is a mapping from high dimensional space onto a plane. However, the lattice can also be more than 2-dimensional, for example a 3-dimensional lattice organized in the shape of a toroid or a spheroid, and also a 4-dimensional lattice formed as a combination of 3-dimensional lattices, or a lattice of even higher dimensionality. Moreover, the lattice is preferably directionally shaped, that is, the dimensions of the lattice along one coordinate axis differ from the dimensions of the lattice along another coordinate axis. The edges of the lattice may be arranged to repeat the structure of the lattice, for example by connecting the adjacent edges of the lattice to each other. Points that are near each other in the input space are mapped to nearby map units in the SOM. The SOM can thus serve as a cluster-analyzing tool of high-dimensional data. Also the SOM has the capability to generalize, which means that the network can recognize or characterize inputs it has never encountered before. A new input is assimilated with the map unit it is mapped to. The Self-Organizing Map may be, for example, a two-dimensional array of neurons. One neuron is a vector called the codebook vector mᵢ=[mᵢₗ, . . . , mᵢₙ]. This has the same dimension as the input vectors. The neurons are connected to adjacent neurons by a neighborhood relation. This dictates the topology, or the structure, of the map.

Automating context creation can help users use data contexts. For example, in one embodiment, a phone is responsible for identifying different data contexts (using metadata/actual data content) and the user only has to name the new data context when the phone is proposing it for the user.

Automatic content creation can include an automated meta-data collection process that uses a background process to save document related meta-data. Based on this meta-data information, a second background process runs which is responsible for finding new data contexts and/or adding new data to the current data contexts. If a new data context is found, it would be suggested to the user and user could name it as he/she likes. It is possible to skip the automatic context creation and use a separate application in which users define the context attributes.

Another example of automatic context creation can include trip planning to Norway. During the trip planning, the user gets e-mails and SMS-messages that are sent to a certain group of people with words like Norway and Hammerfest. Automatic context creation suggests to the user that it has found a new context and after this, show user names that were related to the messaging and keywords that it has found. User can then name the context as ‘Trip to the Norway 2003’. When user is travelling in the Norway and ‘Trip to the Norway 2003’ context is selected, all the pictures that user takes with a device including the data context feature are saved under that data context. When user returns back to home, he/she could select some other data context (e.g. a project in work could have its own data context). If the user wants later access data that is under data context ‘Trip to the Norway 2003’, the user selects this context and is able to see all the data that was saved under that context. Alternatively, the user opens the normal picture viewer application (after selecting the context) for viewing the pictures related to the Norway trip and pictures are automatically filtered according to this data context.

Another example of automatic context creation can include a summer holiday trip to Puumala. During the holiday, a user takes various pictures using his camera phone. An automatic meta-data creator saves location information to the pictures meta-data. That location information (obtained, for example, from an integrated GPS receiver) is enough to suggest new context to the user.

Yet another example of automatic context creation uses the sound environment to trigger a change in data context. The sound environment can be classified whether the user is currently at home, in the office or in the city depending on the surrounding sound environment. For example, if a family goes to an amusement park, saved meta-data information can include location and certain sound context. Such sound information can trigger a suggestion for a new context.

The data context feature can be extended to sub-contexts. For example, if a just married couple is going on a honeymoon to travel around Europe, the main context would be ‘Honey Moon’ and sub-contexts would be for example Rome, Paris, Vienna and St. Petersburg. Sub-contexts can also contain sub-contexts and so on. Using this idea, data contexts can form a tree structure.

By way of implementation, the data contexts can be supported using an operating system file system. One such approach is to map a certain drive letter to a certain file system directory. Each data context would have its own directory. When data context is changed, data context framework would need only to change the drive letter mapping to the selected data context directory (user does not need to know about these directories). Using this kind of approach, the data context functionality could be implemented with minimal changes to applications. Another approach is to implement applications so that they support data contexts directly. This implementation would mean that applications should be re-implemented to classify what data is shown and what is not. Another implementation alternative is to have one context-aware application that is used to browse data.

While several embodiments of the invention have been described, it is to be understood that modifications and changes will occur to those skilled in the art to which the invention pertains. For example, although particular embodiments and implementations describe contemplate use of the data context functionality with a communication device, such as a phone, other electronic devices may also include the functionalities described herein. Accordingly, the claims appended to this specification are intended to define the invention precisely.

1. A method of presenting information based on a context, said method comprising:
defining a context;
selecting a relevant context; and
providing a user with information based on satisfying said relevant context.

2. The method of claim 1, wherein said context comprises keywords.

3. The method of claim 1, wherein said context is automatically defined by the metadata attached to said information.

4. The method of claim 3, wherein said automatic definition of said context utilizes a self-organizing map.

5. The method of claim 1, wherein the user defines said context.

6. The method of claim 1, wherein said providing the user with said information only satisfying said relevant context comprises filtering information to permit only said information pertaining to said relevant context to be provided to the user.

7. The method of claim 1, wherein said selecting said relevant context comprises detecting a context trigger.

8. The method of claim 7, wherein said context trigger comprises location information.

9. The method of claim 7, wherein said context trigger comprises environment-specific information.

10. The method of claim 7, wherein said context trigger comprises time-dependent information.

11. The method of claim 1, further comprising adding information to said relevant context.

12. The method of claim 1, further comprising sharing said context descriptive data and said information relevant to a said context between a groups of users.

13. The method of claim 1, wherein information belongs to a plurality of contexts.

14. A system for presenting information based on a context, said system comprising:
an application, that requests information;
a database containing context descriptive data; and
a filter that restricts information to the application to information pertaining to the selected context based on said corresponding context descriptive data from said database.

15. The system of claim 14, wherein said context descriptive data comprises keywords.

16. The system of claim 14, wherein said filter is integrated into a browser application.

17. The system of claim 14, wherein said filter is integrated into a file management system.

18. The system of claim 14, where in said filter is implemented as a separate layer between browser application and said requesting application.

19. The system of claim 14, where in said filter is implemented as a separate layer between file management system and said requesting application.

20. A device that handles data based on a context, said device comprising:
a memory containing context descriptive data;
a user interface that presents information conforming to a selected data context; and
a processor that executes instructions to obtain context descriptive data from said memory, select a context, and restrict information available for presentation on said user interface to said context descriptive data matching information.

21. The device of claim 20, wherein said context is selected based on user input.

22. The device of claim 20, wherein said context is selected automatically based on instructions executed by said processor.

23. The device of claim 20, wherein information is added to said context based on associated metadata.

24. A computer program product that limits information presented to a user via a user interface to information satisfying a selected context, said computer program product comprising:
computer code to define a context;
computer code to select a relevant context;
computer code to add information to said relevant context; and
computer code to provide information satisfying said context.

25. The computer program product of claim 24, wherein said selection is based on user input.

26. The computer program product of claim 24, wherein said selection is based on automated instructions.

27. The computer program product of claim 24, wherein more than one said context may be selected at a time.

28. The computer program product of claim 24, wherein said relevant context may comprise sub-contexts.

29. The computer program product of claim 24, wherein said computer code to provide information satisfying said context is integrated into said computer code for a browser application.

30. The computer program product of claim 24, wherein said computer code to provide information satisfying said context is integrated into said computer code for a file management system.

31. A module that automates information presentation based on a data context, said module comprising:
a memory containing context descriptive data for a plurality of contexts; and
a filter that restricts information to applications to information satisfying relevant context based on corresponding context descriptive data from said memory.

32. The module of claim 31, wherein said context descriptive data comprises keywords.

33. The module of claim 31, wherein said filter is integrated into a browser application.

34. The module of claim 31, wherein said filter is integrated into a file management system.
